(19) United States
(12) Patent Application Publication
(10) Pub. No.: US 2007/0125887 A1
(43) Pub. Date: Jun. 7, 2007

(54) Steam cover for de-icing and thawing surfaces and equipment

(76) Inventor: John Schwarz, Lethbridge (CA)

Correspondence Address: GOWLING LAFLEUR HENDERSON LLP, SUITE 1400, 700 2ND ST. SW, CALGARY, AB, T2P 4V5, CA

(21) Appl. No.: 11/412,124

(22) Filed: Apr. 27, 2006

(30) Foreign Application Priority Data
Dec. 6, 2005 (CA) 2,526,179

(51) Int. Cl. B05B 1/20

(52) U.S. Cl. 239/566; 239/288; 239/128; 239/135; 99/483; 126/369; 126/377.1

(57) ABSTRACT

A steam cover or blanket for use in de-icing and thawing frozen objects and surfaces, the cover comprising an inlet for receiving steam, upper and lower layers defining a steam passage area therebetween, and a plurality of evenly spaced apertures extending through the lower layer from the steam passage area for allowing release of the steam adjacent the frozen objects and surfaces. A method is also taught for using the steam cover, comprising positioning the cover adjacent the frozen objects and surfaces, connecting the inlet to a steam source, injecting steam into the inlet, allowing the steam to enter the steam passage area, allowing the steam to exit the steam passage area by means of the apertures, and allowing the steam to contact the frozen objects and surfaces.

### FIELD OF THE INVENTION

The present invention relates to de-icing and thawing means and methods, and more particularly to means and methods for de-icing and thawing frozen surfaces and equipment.

### BACKGROUND OF THE INVENTION

Frozen work surfaces and equipment can often be encountered in outdoor settings in North America and Europe, which can result in unsafe work conditions and a negative impact on equipment functionality. This is particularly so in the oil and gas industry, where drilling rigs must be regularly de-iced to ensure a safe and effective working environment.

Various means and methods of de-icing and thawing work surfaces, equipment and pipelines are known in the art, but a few standard means have remained in regular use for many years. Referring to FIG. 1, one of the standard de-icing tools on drilling rigs is the “steam pipe”. A steam pipe 20 is a cylinder with one sealed end, the other end being provided with a hammer union at the inlet 22, the steam pipe 20 supported by a stand 24. The inlet 22 is connected to a source of steam (not shown), which steam is injected into the steam pipe 20, and the underside of the steam pipe 20 is provided with holes 26 for release of the steam adjacent the frozen surface or equipment (not shown). The steam pipe 20 is sometimes covered by a plastic sheet (not shown) to increase the extent of the thawed area.

FIG. 2 illustrates another prior art de-icing tool, namely the “steam barrel”. A steam barrel 30 is usually a plastic barrel cut in half, with a hammer union installed as an inlet 32. Steam from a source (not shown) is injected into the inlet 32 and can then spread across the frozen surface (not shown) underlying the steam barrel 30. This tool is limited in application and is primarily directed to thawing frozen surfaces.

FIG. 3 illustrates yet another common de-icing tool, the “steam wand”. A steam wand 40, often of homemade construction, is a hand-held tool comprising an inlet 44 controlled by a ball valve 46 for allowing steam injection from a source (not shown), with a pinched end 42 at the outlet for increasing the ejected steam pressure. The steam wand 40 provides directional steam application rather than for blanketing over a large area, so it tends to be more time-consuming than other tools. Although it is a hand-held tool, the steam wand 40 does not incorporate handles, and a user usually wraps a cloth around the tool to try to prevent burns from the steam-generated heat.

Other means, including petroleum-fuelled heater units, are known in the art and have found some use. In some cases, users even spread coal, wood or straw over the frozen area and burn it to thaw the area, a time consuming process that results in substantial cleaning time afterwards. De-icing chemicals are also sometimes used, although the environmental impact of their use must be considered.

However, all of the means presently in use, including those discussed above, suffer from some limitation. Some of the means are very costly, such as petroleum-fuelled heaters, while others like the steam wand are extremely unsafe. Whether unsafe, ineffective, of limited application, or simply cost-prohibitive, the existing de-icing and thawing means are not answering the clear need in many industries that must function in outdoor winter conditions.

What is needed, therefore, are a means and method for de-icing or thawing frozen work surfaces and equipment, which means are preferably safe, effective and relatively inexpensive to manufacture. Such means and method should be environmentally friendly, as well as applicable to numerous different work settings, from frozen work areas to frozen pipes.

### SUMMARY OF THE INVENTION

The present invention accordingly seeks to provide a cover, or “steam blanket”, capable of distributing steam across the affected area or equipment, and a method for using same.

According to a first aspect of the present invention there is provided a generally planar cover for use in de-icing and thawing frozen objects and surfaces, the cover comprising:
an inlet for receiving steam from a source;
upper and lower layers defining a steam passage area therebetween, the steam passage area in communication with the inlet; and
at least one aperture extending through the lower layer from the steam passage area for allowing release of the steam adjacent the frozen objects and surfaces.

According to a second aspect of the present invention there is provided a method for de-icing and thawing frozen objects and surfaces, the method comprising:
(a) providing a cover comprising:
   an inlet;
   upper and lower layers defining a steam passage area therebetween, the steam passage area in communication with the inlet; and
   at least one aperture extending through the lower layer from the steam passage area;
(b) positioning the cover adjacent the frozen objects and surfaces;
(c) connecting the inlet to a steam source;
(d) injecting steam from the steam source into the inlet;
(e) allowing the steam to enter the steam passage area;
(f) allowing the steam to exit the steam passage area by means of the at least one aperture; and
(g) allowing the steam to contact the frozen objects and surfaces.

In exemplary embodiments of the present invention, the cover comprises a plurality of apertures through the lower layer, which apertures are most preferably evenly spaced across the lower layer. Preferably, each aperture is provided with a grommet, the source is a steam line, and each of the upper and lower layers comprise an inner sub-layer adjacent the steam passage area and an outer sub-layer.

Where each of the upper and lower layers comprise an inner sub-layer adjacent the steam passage area and an outer sub-layer, the inner sub-layer is preferably composed of a waterproof material, most preferably vinyl, and the outer sub-layer is preferably composed of canvas.

The cover preferably but not necessarily comprises at least one handle for enabling movement and positioning of the cover, and the handle is most preferably composed of nylon.

In preferred embodiments, the inlet comprises a female threaded fitting for threadable mating with the source, and the upper and lower layers are mechanically fastened at their respective peripheral edges, with the upper and lower layers most preferably being further fastened by evenly spaced rivets.

A cover or “steam blanket” according to the present invention, then, can provide numerous advantages over the prior art tools and techniques. The cover can be connected directly and threadably to a steam line, avoiding direct user contact with the steam. Further, the preferable use of handles also helps ensure that a user is isolated from the steam and any portion of the cover that might be of elevated temperature due to the presence of the steam. While providing a structure that can be sized for any application over frozen surfaces or against frozen equipment, with quick and even heating, a cover according to the present invention can also eliminate the need for plastic tarps, bulky and unsafe steam pipes, and homemade steaming accessories.

A detailed description of an exemplary embodiment of the present invention is given in the following. It is to be understood, however, that the invention is not to be construed as limited to this embodiment.

### BRIEF DESCRIPTION OF THE DRAWINGS

In the accompanying drawings, which illustrate prior art tools and an exemplary embodiment of the present invention:

FIG. 1 is an elevation view of a prior art steam pipe;

FIG. 2 is a side elevation view and front elevation view of a prior art steam barrel;

FIG. 3 is an elevation view of a prior art steam wand;

FIG. 4a is a top plan view of a cover or steam blanket according to the present invention, partially cut away to show the inner sub-layer of the upper layer;

FIG. 4b is a bottom plan view of the cover of FIG. 4a, partially cut away to show the inner sub-layer of the lower layer;

FIG. 5 is a cross-sectional view along line 5′-5′ of FIG. 4a;

FIG. 6 is a detailed cross-sectional view showing the sub-layering of the upper and lower layers; and

FIG. 7 is a flowchart illustrating a method according to the present invention.

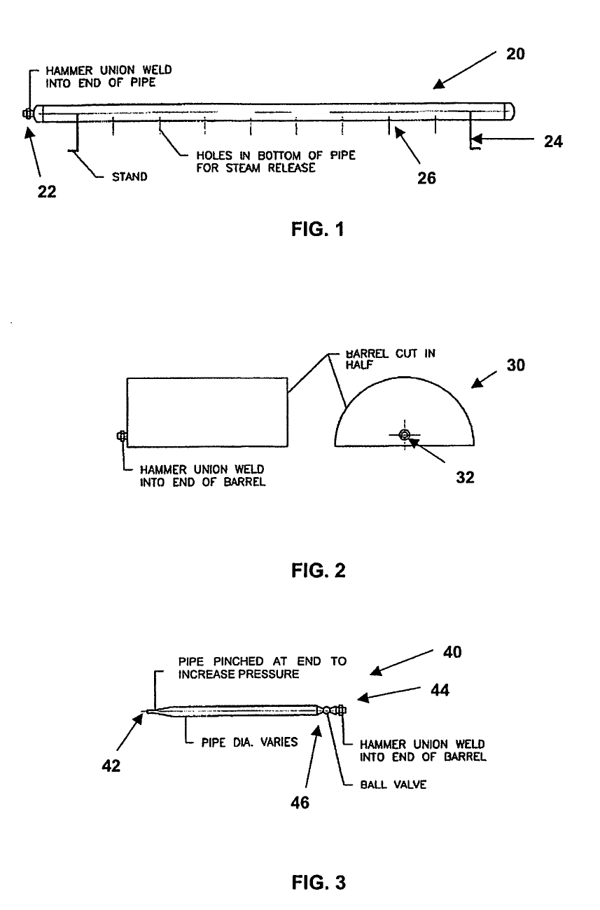

### DETAILED DESCRIPTION OF A PREFERRED EMBODIMENT

Referring now in detail to the accompanying drawings, there is illustrated an exemplary embodiment of a cover or “steam blanket” according to the present invention generally referred to by the numeral 10.

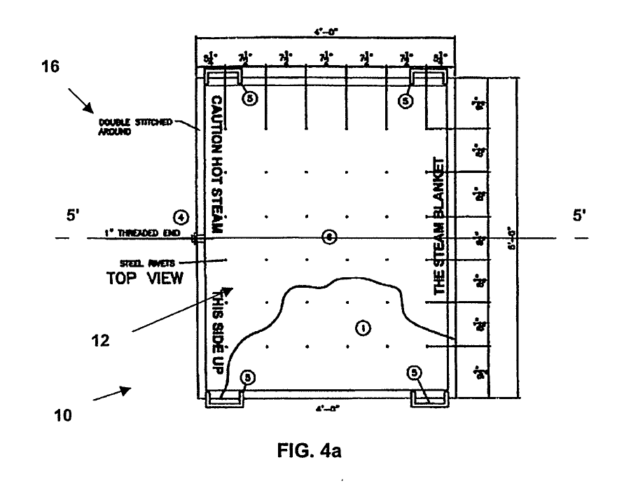

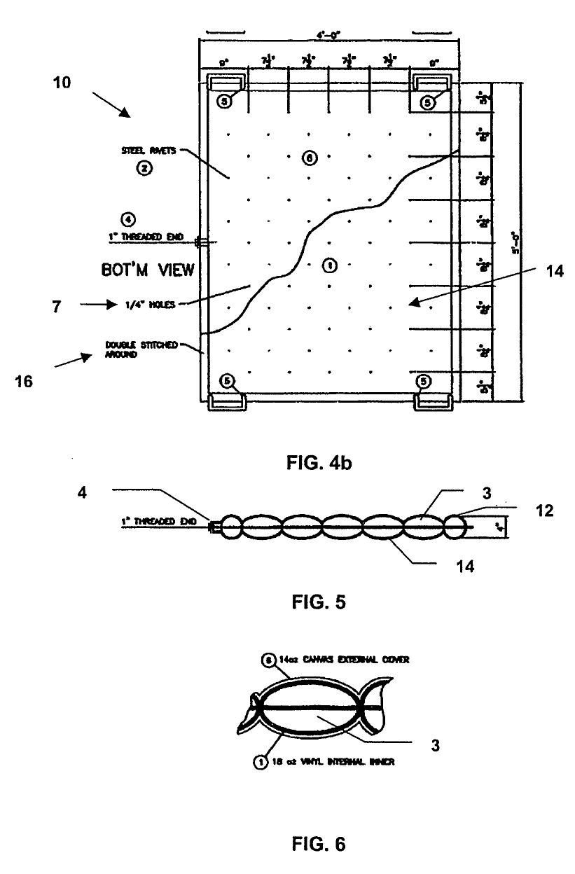

Referring specifically to FIGS. 4a and 4b, there is illustrated an exemplary embodiment of a cover 10 for use in de-icing and thawing frozen objects and surfaces (not shown). The cover 10 comprises an inlet 4 for receiving steam (not shown) from a source (which can be a steam line; not shown), and upper and lower layers 12, 14. The inlet 4 comprises a female threaded fitting which is sized for threadable mating with the source.

The upper and lower layers 12, 14 define a steam passage 3 therebetween (see FIG. 5) for flow of the steam from the inlet 4 to apertures 7 which pass through the lower layer 14; the apertures 7, which are spread evenly across the lower layer 14 of the cover 10, act as egress means for the steam that has been injected into the steam passage 3 of the cover 10. The apertures 7 can be provided with grommets (not shown) to enhance the integrity of the openings.

The upper and lower layers 12, 14 are mechanically fastened together, and in this exemplary embodiment the fastening is by means of double-stitching 16 with waterproof nylon thread along the peripheral edge of the cover 10. The upper and lower layers 12, 14 are further fastened together by means of rivets 2 evenly spaced across the cover 10.

The cover 10 is further provided with handles 5 along the peripheral edge thereof, to isolate the user (not shown) from any steam or steam-heated cover 10 parts. The handles 5 are preferably but not necessarily composed of nylon. In addition, a cover 10 according to the present invention can be provided with warning labels on the upper layer 12, as can be seen in FIG. 4a, a further safety feature to help protect the user.

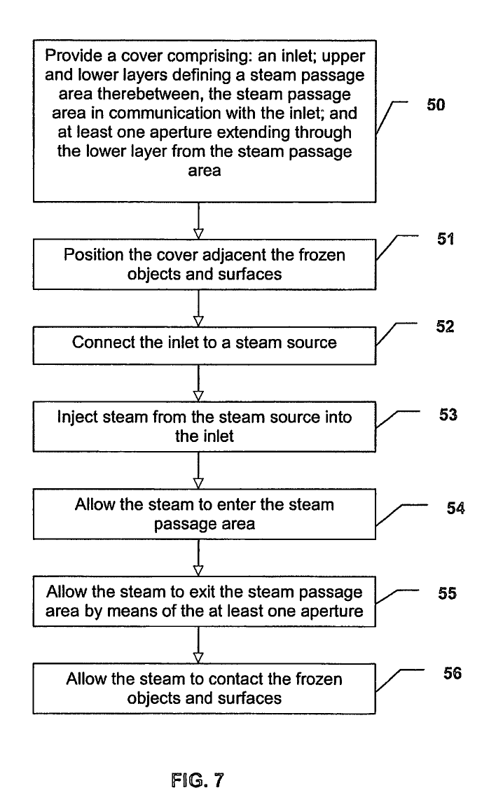

The upper and lower layers 12, 14 of the cover 10 each comprise an inner sub-layer 1 and an outer sub-layer 6, which can be seen by reference to FIG. 6. The inner sub-layer 1 is preferably composed of a waterproof material, and in the exemplary embodiment is composed of fire resistant, mildew resistant, and waterproof 18 oz. vinyl. The outer sub-layer 6 is composed of 14 oz. treated canvas in the exemplary embodiment to enhance user protection and durability of the cover 10.

FIG. 7 illustrates an exemplary method according to the present invention for de-icing and thawing frozen objects and surfaces. The user begins by providing a cover at step 50, the cover comprising: an inlet; upper and lower layers defining a steam passage area therebetween, the steam passage area in communication with the inlet; and at least one aperture extending through the lower layer from the steam passage area. At step 51, the user then positions the cover adjacent the frozen objects and surfaces, and then connects the inlet to a steam source at step 52. At step 53, steam is injected from the steam source into the inlet, and the steam is allowed to enter the steam passage area at step 54. The steam is allowed to exit the steam passage area at step 55 by means of the at least one aperture, and the steam is finally allowed to contact the frozen objects and surfaces at step 56.

While a particular embodiment of the present invention has been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiment. The invention is therefore to be considered limited solely by the scope of the appended claims.

1. A generally planar cover for use in de-icing and thawing frozen objects and surfaces, the cover comprising:
an inlet for receiving steam from a source;
upper and lower layers defining a steam passage area therebetween, the steam passage area in communication with the inlet; and
at least one aperture extending through the lower layer from the steam passage area for allowing release of the steam adjacent the frozen objects and surfaces.

2. The cover of claim 1 comprising a plurality of apertures through the lower layer.

3. The cover of claim 2 wherein the plurality of apertures are generally evenly spaced across the lower layer.

4. The cover of claim 1 wherein the at least one aperture is provided with a grommet.

5. The cover of claim 1 wherein the source is a steam line.

6. The cover of claim 1 wherein each of the upper and lower layers comprise an inner sub-layer adjacent the steam passage area and an outer sub-layer.

7. The cover of claim 6 wherein the inner sub-layer is composed of a waterproof material.

8. The cover of claim 6 wherein the inner sub-layer is composed of vinyl and the outer sub-layer is composed of canvas.

9. The cover of claim 1 further comprising at least one handle for enabling movement and positioning of the cover.

10. The cover of claim 9 wherein the at least one handle is composed of nylon.

11. The cover of claim 1 wherein the inlet comprises a female threaded fitting for threadable mating with the source.

12. The cover of claim 1 wherein the upper and lower layers are mechanically fastened at their respective peripheral edges.

13. The cover of claim 12 wherein the upper and lower layers are further fastened by evenly spaced rivets.

14. A method for de-icing and thawing frozen objects and surfaces, the method comprising:
(a) providing a cover comprising:
an inlet;
upper and lower layers defining a steam passage area therebetween, the steam passage area in communication with the inlet; and
at least one aperture extending through the lower layer from the steam passage area;
(b) positioning the cover adjacent the frozen objects and surfaces;
(c) connecting the inlet to a steam source;
(d) injecting steam from the steam source into the inlet;
(e) allowing the steam to enter the steam passage area;
(f) allowing the steam to exit the steam passage area by means of the at least one aperture; and
(g) allowing the steam to contact the frozen objects and surfaces.
